(19) United States
(12) Patent Application Publication
(10) Pub. No.: US 2016/0005232 A1
(43) Pub. Date: Jan. 7, 2016

(54) UNDERWATER VIRTUAL REALITY SYSTEM

(71) Applicant: JOHN QUARLES, San Antonio, TX (US)

(72) Inventor: JOHN QUARLES, San Antonio, TX (US)

(73) Assignee: THE UNIVERSITY OF TEXAS AT SAN ANTONIO, San Antonio, TX (US)

(21) Appl. No.: 14/792,162

(22) Filed: Jul. 6, 2015

Related U.S. Application Data
(60) Provisional application No. 62/021,077, filed on Jul. 4, 2014.

(51) Int. Cl. G06T 19/00; B63C 11/20; G06F 3/16; G02B 27/01; G06F 3/01

(52) U.S. Cl. CPC G06T 19/006; G02B 27/017; G06F 3/012; G06F 3/16; B63C 11/20

(57) ABSTRACT

Embodiments are directed to virtual reality methods and/or apparatus for providing a user with an underwater virtual reality experience that causes the user to experience the virtual reality environment, and to interact with the virtual reality environment in addition to experiencing the sensations of the real underwater environment.

This application claims priority to U.S. Provisional Patent Application Ser. No. 62/021,077, filed Jul. 4, 2014, which is incorporated herein by reference in its entirety.

### BACKGROUND

This method and apparatus relates to a field of underwater virtual reality.

It is known in the prior art to provide users with virtual reality systems. The ability for these systems has increased as technologies have been developed for providing greater image quality, lower prices, and enhanced ability to integrate the real world with the virtual reality in order to provide a more realistic experience. Presently, most virtual reality systems focus on engaging the visual and audio senses of a user.

U.S. Pat. No. 5,271,106 discloses a swimming pool producing surrounding visual effects utilizes large picture generating surfaces adjacent to water-containing surfaces for displaying large images emulative of remote swimming environments.

U.S. Patent Application Publication No. 2004/0086838 discloses a diving simulator system which includes an interactive submersible diver apparatus having a computer monitor and user input control, a source of selectable underwater three dimensional virtual images and information relating to a diving site, and a computer interconnected between the source and the diver apparatus and programmed to selectively present diving site images and information to the apparatus in response to user input.

U.S. Pat. No. 8,195,084 discloses an invention that is directed towards a virtual reality apparatus that provides a user with an extra-terrestrial somatosensory experience to virtualize the experience of being in space. The apparatus includes an underwater environment in which the user may be immersed and a computer-implemented virtual reality system that presents to the user a virtual reality environment within the underwater environment, the virtual reality environment modeling an extra-terrestrial setting.

### SUMMARY

Certain embodiments of the invention are directed to a virtual reality system or apparatus (VRS) for providing a user with an underwater virtual reality experience. In certain aspects the virtual reality system or apparatus comprises a display component, a sensor component, and a computing component. In a further aspect the VRS comprises an underwater breathing device or apparatus that allows the user to be fully or partially immersed in water. In still a further aspect the VRS can comprise an audio device, a microphone, or an audio device and a microphone.

The system is configured to present to the user a virtual reality environment modeling an underwater setting (providing a virtual underwater setting). In certain embodiments the virtual underwater setting is provided on a display or in a display device. In certain aspects the display is included in a head mounted device or a device that attaches to the user's head or face or eye region of the face (a display device). In certain aspects the display device covers all or a portion of the user's face. In still another aspect the display device can further cover all or part of the user's ear(s). In a further aspect the display device covers all or a part of the user's face and all or a portion of the user's head. In certain embodiments the display is a head-mounted display system, such display system including at least one sensor to identify at least one of position and motion of the user's head. The head-mounted display system can be integrated with an underwater breathing apparatus for use by the user and is operative in an actual underwater environment. The underwater breathing apparatus can be a mask configured to provide for breathing through the mouth or used in conjunction with a mouth piece that is connected to a breathing apparatus, a self-contained breathing apparatus, or a snorkel worn by the user. In certain aspects the display device is integrated into a mask or helmet. In certain aspects the display or display device is configured to inhibit or block the user's visual perception of the actual environment in which the user is actually located, i.e., the environment outside of the virtual reality system or the display or display device. In certain aspects the actual environment is a tub, pool, or other artificial container with water. In a further aspects the actual environment can be a pond, lake, or other body of water.

The display device can comprise or be in communication with 1, 2, 3, 4, or more sensors. In certain aspects a sensor gathers data to be communicated to computing component of the system. In a further aspect at least one sensor is positioned or configured to provide information regarding the position of the user's head. One or more sensors can be configured to provide information regarding the movement of the user's head, e.g., direction, speed, velocity, angle, etc. Additional sensors can be located on one or more body part or limb to monitor the position and/or movement of the user's body (e.g., torso) and/or limbs, for example sensors can be placed on each hand and the position and/or movement of the hands can be monitored and communicated to the computing device. In certain aspects a first sensor is mounted on the head and a second sensor is mounted on the user's chest, the second sensor detecting body orientation and user movement. In some embodiments the second sensor in wirelessly networked with the first sensor. In some embodiments the first and second sensors are mobile computing devices such as smartphones. The data received from the various sensors can be used by the computing device to alter the display of the virtual environment relative to the user's position and movement. i.e., integrate the user into the virtual reality display. The integration of the display, sensor(s), and computing device provides a virtual reality environment for an underwater experience in which a user can interact while experiencing the benefits and sensations of an actual underwater environment. In certain embodiments a senor can be a waterproof smart phone or other mobile computing device. The waterproof mobile computing device can be attached to a mask or other accessory for attachment to the user's head. In certain aspects a sensor mounted on the chest can be a second waterproof smart phone or mobile computing device that is wirelessly networked with a first waterproof smart phone or other mobile computing device attached to the mask or head. In some embodiments the first and second smart phone or other mobile computing device are networked in an ad hoc network. In another embodiment the second smart phone or other mobile computing device is networked with the first smart phone or other mobile computing device which is acting as a mobile hotspot.

In certain embodiments the computing device is in communication with the one or more sensors and the display device. In certain aspects the computing device can be attached to (i) the user and in communication with the display device (e.g., attached to the user's torso or limb and in wireless communication with the display system), (ii) attached to the display device and in communication with the display device, or (iii) positioned remotely and in wired or wireless communication with the display device and one or more sensor. In certain aspects the computing device can be a mobile computing device. In a further aspect the mobile computing device is a smartphone, tablet, laptop, or the like. In certain aspects the computing device can comprise a controller integrated or removably integrated into a display device (e.g. a water proof compartment that can be opened, a mobile device plugged into the device, and the compartment closed and sealed before entering the water). The computing device can be located in a water proof compartment. In certain aspects the computing device is programmed to be in communication (wired or wireless) with the display or display device and the sensor(s), and to provide and manage an underwater virtual reality environment. The computing device is configured to receive and transmit data and instruction for the presentation and dynamic manipulation of the virtual underwater environment. In certain aspects the computing device is configured to provide audio or tactile sensation through speakers or tactile manipulators. In certain aspects the audio and/or tactile stimulation is synchronized with the virtual reality display.

Certain embodiments are directed to a method for providing a user an underwater virtual reality experience while the user is actually underwater or partially submerged in water. The method can comprise immersing a user having a virtual reality system as described herein appropriately attached to the user. The user can be equipped, connected, or attached with or to an underwater breathing apparatus, a display device, a computing device, and one or more sensors. In certain aspects, the method comprises displaying a virtual underwater environment on a display while the user is immersed or partially immersed in water using a computing device. The method can further comprise monitoring the user's position and/or movement, and adjusting the virtual environment in relation to the user's position and/or movements. In a further aspect the computing device can provide for the display of virtual objects that the user can virtually interact with using body movements and/or positioning. The term water as used herein refers to an aqueous solution that is at least 50, 55, 60, 65, 70, 75, 80, 85, 90, or 95% water, such as fresh water, salt water, pool water, etc.

Certain aspects include presenting a virtual environment to a user that is underwater. The virtual environment is presented using a computer or mobile computing device implementing virtual reality system and/or program described herein. In certain aspect the virtual environment is an underwater setting. Methods include monitoring the movement of the user's body and displaying a representation of the movement in the virtual environment. The user being immersed or partially submerged in water allows the user to experience the benefits (e.g., cooling, hydrostatic support, etc.) and sensations (e.g., buoyancy, resistance, etc.) of the real underwater environment.

Certain embodiments of the invention are methods for providing an underwater virtual reality game that activates all 5 senses of a user through a tracked stereoscopic view of the game, 3D sound from both the game and the real water, the smell of the water, the taste of the snorkel, and haptic feedback from the water.

Other embodiments of the invention are discussed throughout this application. Any embodiment discussed with respect to one aspect applies to other aspects as well and vice versa. Each embodiment described herein is understood to be embodiments that are applicable to all aspects of the invention. It is contemplated that any embodiment discussed herein can be implemented with respect to any device, method, or composition, and vice versa. Furthermore, systems, compositions, and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1. Illustrates the system components involved in one embodiment of the invention, the Shark Punch game.

FIG. 2. Illustrates a user of the disclosed underwater virtual reality system, and the image provided to the user by the display device while the system register's a user's body movement during a punch action.

### DETAILED DESCRIPTION

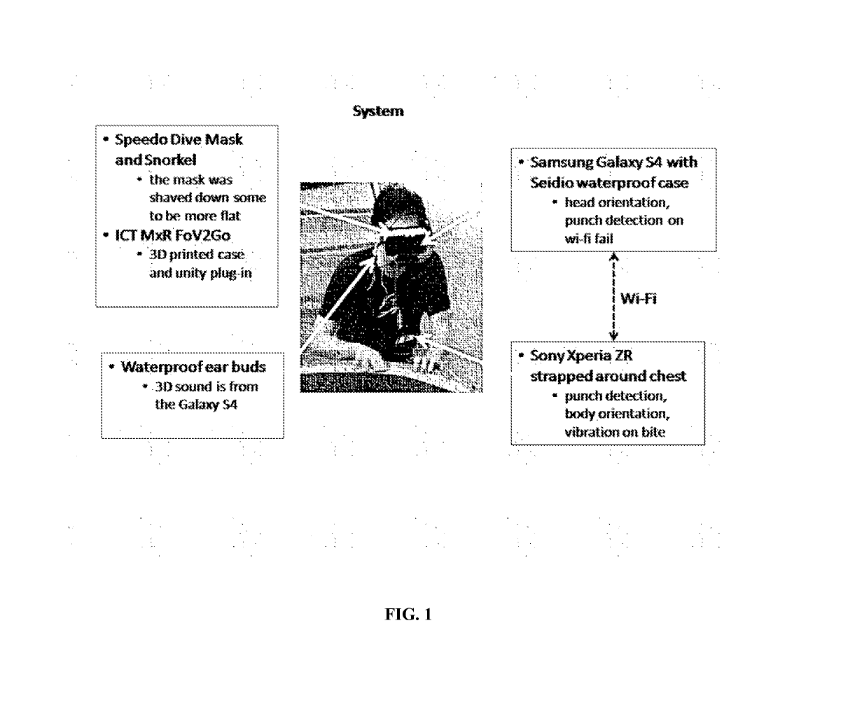

Certain embodiments include methods and systems for underwater virtual reality through implementation of various elements and components, of which certain ones are shown in an exemplary embodiment for descriptive clarity. It is noted that in various embodiments of underwater virtual reality systems, desired elements may be added and/or undesired ones omitted. The description of underwater virtual reality system in FIG. 1 is intended as a functional representation, and is not intended to restrict any specific physical implementation to a particular form or dimension. For example, a different implementation of a simulator may be employed with different types of sensors, display devices, and rendered virtual environments as is suitable and/or desired.

The underwater virtual reality system may include a computer to process the data from various sensors and render the virtual environment for display. This computer includes processor and memory. Processor may represent at least one processing unit and may further include internal memory, such as a cache for storing processor executable instructions. In certain embodiments, processor serves as a main controller for the simulator. In various embodiments, processor is operable to perform operations associated with virtual reality system, as described herein.

In some embodiments the underwater virtual reality system may use several microcomputers or “micro-controllers,” so that multiple channels of data can be detected and the key information sent to a computer to computing device to render and display simulated results. A micro-controller is a small computer on a single integrated circuit containing a Processor, Memory, and programmable input/output peripherals.

Memory encompasses persistent and volatile media, fixed and removable media, magnetic and semiconductor media, or a combination thereof. Memory is operable to store instructions, data, or both. Memory includes program instructions, which may be in the form of sets or sequences of executable instructions, such as applications or code for performing kicking simulation. Memory is further shown including data from sensors representing measured values for the motion of the user of the virtual reality system that have been acquired during use of the system. In certain embodiments, data may further include reference values for motion data and/or other parameters that may be used to analyze data acquired for specific virtual simulations, as will be described in further detail below. It is noted that memory may be available to processor for storing and retrieving other types of information and/or data, as desired.

The disclosed invention may be used for underwater virtual reality (VR) games, which have applications to fitness, training, and rehabilitation. For example, multiple sclerosis (MS) is neurological disease that commonly causes balance deficits, numbness in the extremities, and fatigue. Unfortunately, these symptoms are exacerbated by heat. Thus, for persons with MS, physical therapists recommend underwater rehabilitation, which is made more fun and motivating through incorporation of virtual reality experiences or games.

Certain embodiments of the invention will include a plurality of sensor(s), which represents one or more sensors (i.e., transducers) for capturing the motion of the user and/or objects interacting with the user. Sensor(s) may be configured to measure motion associated with the user over a number of different dimensions and/or axes. Specifically, sensor(s) may measure individual orthogonal axes of 3-dimensional linear motion corresponding to a Cartesian coordinate system of X, Y, and Z axes. In various embodiments, sensor(s) may also be configured to measure a number of different axes of rotation. The placement (i.e., orientation) of a physical embodiment of sensor(s) relative to the user (or a portion of the user, such as the user's limbs or torso) may determine an orientation of the coordinate system. Sensor(s) may represent a number of different types of sensors, such as, but not limited to, accelerometers, gyroscopes, Hall-effect sensors, optical sensors, radio-frequency sensors, among others. In certain embodiments, sensor(s) include microelectromechanical systems (MEMS) and/or nanoscale components. Processor may be configured to receive motion data from sensor(s) and store these motion data in memory. It is noted that, in some embodiments, sensor(s) may include functionality for supplying power, signal conditioning, and/or digitization of motion signals to generate motion data, such as amplifiers and analog-to-digital converters, etc. In some embodiments sensors may be integral to mobile computing devices such as a smart phone, tablet computer, iPod Touch, or various system on a chip implementations. Such system on chip devices may include by not be limited to an arduino microcontroller or raspberry pi computer.

The various components of the invention communicate with one another via various communication interfaces. In certain embodiments, communication interface supports wireless communication links, such as infrared (IR), radio frequency (RF), and audio, among others. Examples of RF wireless links include the IEEE 802.××family, such as WiFi® (IEEE 802.11), 2.4 ghz Wireless Modules, and Bluetooth® (IEEE 802.15.1). In addition to wireless communication links, communication interface may further support mechanically connected communication links, such as galvanically wired connections, sensor interface connections, connections to external antennas, HDMI, USB, network connections, etc., and may accordingly include a physical adapter or receptacle for receiving such connections. Communication interface may transform an instruction received from processor into a signal sent via a communication medium, such as a network link. It is noted that communication interface may be a bidirectional interface, such that responses, such as commands, information, or acknowledgements, may be received.

The invention also incorporates a display. The display may be implemented as a liquid crystal display screen, a OLED display, or the like. The display may be the display found on a mobile computing device such as a smartphone. In certain aspects the display may be a 3D display, or may use various techniques such as display splitting and use of lenses to simulate a 3D display. Display device may be mounted on a structure that is configured to cover the user's eyes, and securely and stably mount the display in front of the user's eyes. The display may include additional output devices such as one or more integrated speakers to play audio content, or may include an input device such as a microphone and/or video camera. Control elements may represent physical or virtual controls, such as buttons, knobs, sliders, etc., that may be operated by the user and/or other operator. In particular embodiments, control elements may include virtual control elements displayed by display, or other device attached to the user and operable using a touch sensor, which may be a touch screen associated with the display, or other tactile sensor. Accordingly, control elements may represent static as well as dynamic controls that may be reconfigured for various input and output functions, as desired. A sound device may be some type of speaker, headphone, or earbud, and may be connected to the rest of the system by either wireless or wired connection(s). The sound device may be physically mounted to the the display device or the device supporting a display device.

In some embodiments the display presents to the user a virtual reality environment within the underwater environment, the virtual reality environment modeling an underwater setting, and can inhibit visual and/or audio perception by the user of items outside of the virtual reality environment. In some embodiments cameras, either separate, or integral to the sensor or computing devices may be used to provide an “augmented” reality experience wherein a direct or indirect view of the, real-world underwater environment has elements that are augmented (or supplemented) by computer-generated sensory input such as sound, video, graphics or GPS data.

One illustrative embodiment of the disclosed invention is an immersive underwater virtual reality game called Shark Punch. Shark Punch is a novel underwater virtual reality game (VR) in which players must fight for their lives in a real underwater environment against a virtual Great White shark. The shark circles the player and then it ferociously attacks, but it can only be fended off if the user lands a real punch on the virtual shark's nose. The game activates all 5 senses through a tracked stereoscopic view of the game, 3D sound from both the game and the real water, the smell of the water, the taste of the snorkel, and haptic feedback from the water.

In certain embodiments, the game uses a waterproof smart phone attached to a dive mask to enable a 3DOF tracked stereoscopic view of the virtual underwater environment. In certain aspects, another waterproof smart phone can be attached to the player's chest, allowing for 3DOF body orientation tracking and punch detection. The phones can be wirelessly networked. The sounds of the game—e.g., shark swimming, shark bite “crunch”, punch landing, human screaming—are all delivered through water proof headphones and are provided in conjunction with the real sounds being heard underwater.

A non-limiting example of system components are shown in FIG. 1. These components were used in the creation of a Shark Punch game. Unity 3D 4.5 was used as the game engine to render the interactive game on the smartphone attached to the dive mask. For this embodiment a Samsung Galaxy S4 with Seidio waterproof case was mounted on a Speedo Dive Mask (including a U.S. Divers Island Dry Snorkel) and incorporated with a ICT MxR FoV2Go (3D printed case and unity plug-in). A Sony Xperia ZR waterproof phone was mounted on the user's chest and was wirelessly networked with the Samsung Galaxy S4. No separate wireless router network is required. One phone uses the other as a hotspot and they communicate directly over their local network, or through use of an ad-hoc network. Sound was provided by a pair of Pyle Marine Sport Waterproof In-Ear Ear bud Stereo Headphones worn by the user and connected to the Samsung Galaxy S4.

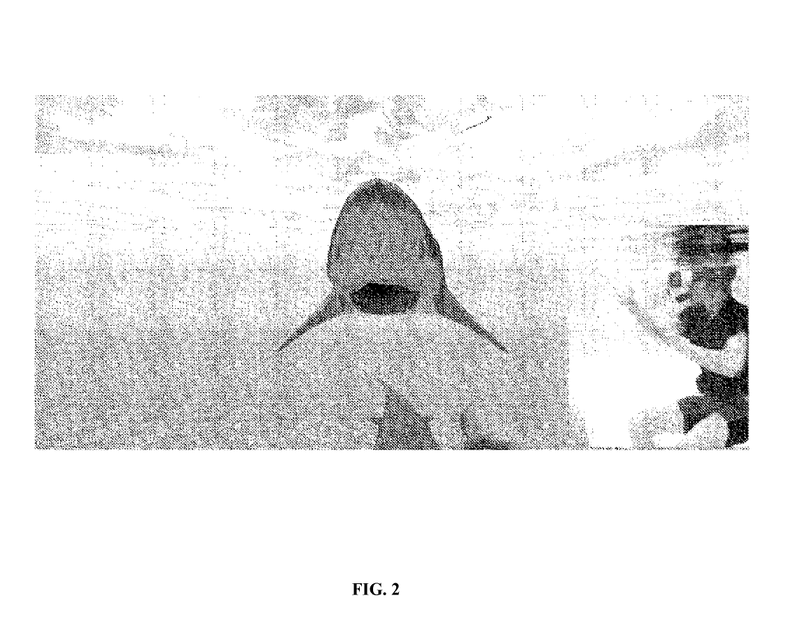

As seen in FIG. 2 an Animated human model from Mixamo was used in the game engine so that when the sensors detected the user punching, the game engine rendered a human arm throwing a punch at the simulated shark. The Animated Shark model was purchased from Turbosquid.com.

After the user is submerged wearing the various components, the first device mounted on the user's head will provide an image or video of a virtual environment to the user. The activity in the image or video will be tailored provide a stimulation to the user to illicit a response by the user. For example, a moving image of a shark may appear to be approaching the user. The first device mounted on the head may be in communication with the second device mounted on the torso. The second device will use its position sensors to determine whether the user has performed an appropriate reaction to the provided stimulus. For example, the user should attempt to punch the shark, the movement of this action would be registered by the positional sensors on the second device and communicated to the first device. If the user does not react to this stimulation in an appropriate manner (such as by throwing a punch) then the first device mounted on the head may send a signal to the second device instructing to perform an action such as vibrating to simulate a “bite”, and/or provide addition visual or auditory stimulus such as an audio scream.

1. A method of providing a user with an underwater virtual reality experience, the method comprising:
providing a user equipped with an underwater breathing apparatus and a virtual reality system located in an underwater environment with a virtual reality environment modeling an underwater setting, the underwater setting being provided by a virtual reality system comprising a computer or mobile computing device connected to a head-mounted display system, and at least one sensor for identifying the position of the user's head and at least one sensor for detecting movement of the user's body, the virtual reality system inhibiting visual perception by the user of items outside of the virtual reality environment;
dynamically modifying the virtual underwater setting in relation to the user's body and audio to simulate user interaction with the virtual underwater environment.

2. A virtual reality apparatus for providing a user with an underwater virtual reality experience, the apparatus comprising:
an underwater breathing apparatus; and
a computer or mobile computing device implemented virtual reality system configured to present to the user a virtual reality environment modeling an underwater setting, the virtual reality system inhibiting visual perception by the user of items outside of the virtual reality environment, wherein said computer or mobile computing device implemented virtual reality system includes a head-mounted display system, such display system worn by the user including at least one sensor to identify at least one position of the user's head, and movement of the user's body which corresponds with the movement of the representation of the user's body in the virtual environment, wherein the display system and the sensors form a part of the computer or mobile computing device implemented virtual reality system that causes the user to experience the virtual reality environment, and to interact with the virtual reality environment in addition to experiencing the sensations of the real underwater environment.

3. The apparatus of claim 2, further comprising an actual underwater environment.
